(19) United States
(12) Patent Application Publication
(10) Pub. No.: US 2023/0171078 A1
(43) Pub. Date: Jun. 1, 2023

(54) HIGH-FREQUENCY WIRELESS DATA COMMUNICATION SYSTEM

(71) Applicant: GLS CO., LTD., Daejeon (KR)

(72) Inventors: Ki Dong SONG, Daejeon (KR); Ki Chan EUN, Daejeon (KR)

(73) Assignee: GLS CO., LTD., Daejeon (KR)

(21) Appl. No.: 17/644,919

(22) Filed: Dec. 17, 2021

(30) Foreign Application Priority Data
Nov. 30, 2021 (KR) 10-2021-0168820
Nov. 30, 2021 (KR) 10-2021-0168845

(51) Int. Cl. H04L 5/14; H04B 1/40

(52) U.S. Cl. CPC H04L 5/14; H04B 1/40

(57) ABSTRACT

Provided is a high-frequency wireless data communication system. More particularly, provided is a high-frequency wireless data communication system in which a first device and a second device are capable of transmitting and receiving data quickly and easily through high-frequency wireless communication. The high-frequency wireless data communication system according to the present disclosure includes a first transceiver module, and a second transceiver module configured to perform wireless communication with the first transceiver module, wherein when data is intended to be transmitted and received, the first transceiver module and the second transceiver module interwork with each other and transmit and receive data in a wireless manner.

### CROSS REFERENCE TO RELATED APPLICATION

The present application claims priority to Korean Patent Application No. 10-2021-0168820, filed Nov. 30, 2021, and Korean Patent Application No. 10-2021-0168845, filed Nov. 30, 2021, the entire contents of which are incorporated herein for all purposes by this reference.

### BACKGROUND OF THE INVENTION

### Field of the Invention

The present disclosure relates to a high-frequency wireless data communication system. More particularly, the present disclosure relates to a high-frequency wireless data communication system in which a first device and a second device are capable of transmitting and receiving data quickly and easily through high-frequency wireless communication.

### Description of the Related Art

Data storage and input/output devices are for storing data therein and inputting and outputting data. Various types of data storage devices, such as USB memories, hard disks installed in PCs, external hard disks, etc., and various types of devices, such as smartphones, tablet PCs, notebook computers, etc., have been developed and commercialized.

Among these devices, USB memories, external hard disks, notebook computers, and smartphones are widely used for excellent portability. In particular, USB memories and smartphones are small in size and thus utilized as the most popular and widely used portable devices.

In the meantime, recently, due to data massiveness caused by information massiveness resulting from large-size and high-resolution displays, and by increases in computer performance and transferred data, there has been an exponentially increasing demand for an increase in the transmission rate for quick transmission of massive data.

With the development of the technology, the capacity of each device and transmission rate between devices have also rapidly increased. In order to respond to the demand for the rapid increase in transmission rate, for example, the USB standard has been developed from USB 1.1 with the maximum transmission rate of 12 Mbps, to USB 3.1 with the maximum transmission rate of 10 Gbps. Although not popularized yet, USB 3.2 with the maximum transmission rate of 20 Gbps is reported to have been developed.

In order to quickly transmit massive data of each device (for example, a smartphone, a tablet PC, a notebook PC, or a USB memory) to another device (for example, another smartphone, tablet PC, notebook PC, or USB memory), a means that can transmit data at very high speed is required. Currently, wired connection, such as USB Type-C, is mainly used.

It is technically easy to perform such very high speed data communication through wired communication such as a USB-C cable as described above. However, since the advent of smartphones, electronic devices have gradually become mobile, and there is a significantly increasing preference for the very high speed data communication to be performed in a wireless manner.

This trend is equally applied to mobile communication. In order to meet the increasing demand for wireless data traffic after the commercialization of 4th-generation (4G) mobile communication systems, next-generation (e.g., 5G or 6G) communication systems are trying to achieve a faster wireless data communication rate. As part of this effort, in the next-generation communication systems, wireless communication using an extremely high frequency (EHF) band (30˜300 GHz) has been realized to achieve a high data transfer rate.

Reflecting this trend, technologies for very high speed wireless data transmission and reception between devices are being developed. A currently developmental technology for very high speed wireless communication between devices uses a chipset having a USB IP (for example, Cypress's FX3), so it has several problems to be solved, such as large power consumption, frequency interference, and an inability to satisfy the transfer rate of 5 Gbps which is the full data transmission rate of USB 3.0.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing a high-frequency wireless data communication system, wherein without using a wired cable, wireless communication between a first device and a second device is performed using an extremely high frequency (EHF) band (30˜300 GHz), thereby achieving very high speed data transmission and reception in a wireless manner.

In addition, the present disclosure is directed to providing a high-frequency wireless data communication system, wherein without using a chipset having a USB IP, high-frequency wireless communication of data is achieved through one chip, so that power consumption due to the use of a USB IP is reduced and the size of the whole communication unit is reduced for optimization for a mobile device.

In addition, the present disclosure is directed to providing a high-frequency wireless data communication system, wherein modulation is performed to have the data transfer rate that is at least twice the data transfer rate between USB devices or USB hosts, and wireless communication is performed, and the transfer rate is restored at the time of reception, so that practical full duplex is achieved or the high-frequency wireless data communication system operating in a time division duplex (TDD) method is used without a reduction in transfer rate.

In addition, the present disclosure is directed to providing a high-frequency wireless data communication system, wherein modulation is performed to have the data transfer rate that is at least twice the data transfer rate between a first device and a second device, and wireless communication is performed, so that practical full duplex is achieved without a reduction in transfer rate.

In addition, the present disclosure is directed to providing a high-frequency wireless data communication system, wherein by applying an RF switching method, high-frequency wireless communication is achieved through one antenna without a reduction in transmission rate.

According to the present disclosure, there is provided a high-frequency wireless data communication system including: a first transceiver module provided or embedded in a first device, and configured to perform wireless communication, the first device being capable of storing data therein or processing data; and a second transceiver module provided or embedded in a second device, and configured to perform wireless communication with the first transceiver module, the second device being capable of storing data therein or processing data, wherein the first and the second transceiver module each include an extremely high frequency (EHF) chip capable of transmitting Gbps data, and when the second device is intended to transmit data to and receive data from the first device, the first transceiver module and the second transceiver module interwork with each other and transmit and receive data in a wireless manner.

According to a preferred embodiment of the present disclosure, the EHF chip of the first transceiver module and the EHF chip of the second transceiver module each may include: a transmission (Tx) path on which data-link layer data is converted into physical-layer data and the physical-layer data is transmitted in a wireless manner; and a reception (Rx) path on which physical-layer data transmitted through wireless communication is converted into data-link layer data and the data-link layer data is transferred.

In addition, the transmission path may include: a data conversion part connected to the first device or the second device, and configured to convert data-link layer data into physical-layer data for wireless communication; and an RF part configured to fuse the physical-layer data into a frequency for conversion into a wireless signal.

In addition, the reception path may include: an RF part configured to separate a frequency from a wireless signal transmitted from the first device or the second device to extract physical-layer data; and a data conversion part connected to the first device or the second device, and configured to convert the physical-layer data into data-link layer data.

In addition, the first transceiver module and the second transceiver module each may further include an antenna for wireless communication.

In addition, the data conversion part may be configured to add, when converting the data-link layer data into the physical-layer data for wireless communication, a preamble to actual transmission data (payload) for transmission timing synchronization.

In addition, the data conversion part may be configured to further add a header for a type, a form, error correction, and error detection for each transmission section of the actual transmission data (payload).

In the meantime, the RF part on the transmission path may include: a phase-locked loop (PLL) configured to generate a predetermined operating frequency; a modulator (Modulator) configured to modulate a signal transferred from the data conversion part, on the basis of a signal generated from the phase-locked loop (PLL); and an amplifier (PA) configured to amplify a signal transferred from the modulator.

In addition, the RF part on the reception path may include: a low noise amplifier (LNA) configured to receive and amplify a predetermined operating frequency signal transmitted from the first transceiver module and the second transceiver module, to minimize noise; a demodulator (Detector) configured to demodulate a signal transferred from the low noise amplifier (LNA); and a limiter configured to remove the noise.

In addition, when performing wireless communication, the first transceiver module and the second transceiver module may perform the wireless communication through a full duplex method.

In addition, during the wireless communication, a frequency in a band ranging from 30 GHz to 300 GHz may be used.

In the meantime, the data conversion part on the transmission path may include: a data controller connected to the first device or the second device, and configured to convert the data-link layer data into the physical-layer data for wireless communication; a modem connected to the data controller, and configured to modulate data resulting from conversion by the data controller into a signal appropriate for wireless transmission; and a SerDes connected to the modem, and configured to serialize a signal.

In addition, the data conversion part on the reception path may include: a SerDes configured to parallelize a signal transferred from the RF part; a modem configured to demodulate the parallelized signal into a physical data signal; and a data controller configured to convert physical data resulting from demodulation into the data-link layer data.

In addition, when modulating data resulting from conversion and transfer by the data controller, the modem may be configured to perform modulation to have a transfer rate that is at least twice a transfer rate of data transmitted from the first device or the second device to the first or the second transceiver module on the transmission path.

In addition, when demodulating data transferred through the SerDes, the modem may be configured to perform demodulation so that a transfer rate of the demodulated data is equal to a transfer rate of data transmitted from the first device or the second device to the first or the second transceiver module on the transmission path.

In addition, the RF part may further include an RF switch connected to an amplifier (PA) or the low noise amplifier (LNA), wherein the RF switch may be configured to connect the amplifier (PA) with an antenna at the time of transmission, and may be configured to connect the low noise amplifier (LNA) with the antenna at the time of wireless reception.

Herein, when performing wireless communication, the first transceiver module and the second transceiver module may perform the wireless communication through a time division duplex (TDD) method.

In the meantime, during the wireless communication, a frequency in a band ranging from 30 GHz to 300 GHz may be used.

According to the present disclosure, without using a wired cable, wireless communication between a first device and a second device is performed using an extremely high frequency (EHF) band (30˜300 GHz), so that very high speed data transmission and reception is achieved in a wireless manner.

In addition, without using a chipset having a USB IP, high-frequency wireless communication of data is achieved with one chip, so that power consumption due to the user of a USB IP can be reduced and the size of the whole communication unit can be reduced.

In addition, wireless communication between a device and the first or second transceiver module is performed using a full-duplex method, so that wireless communication can be achieved without a reduction in transmission rate.

In addition, modulation is performed to have the data transfer rate that is at least twice the data transfer rate between a device and a first or second transceiver module, and wireless communication is performed, so that practical full duplex can be achieved without a reduction in transfer rate or wireless communication using a time division duplex (TDD) method can be achieved without a reduction in transfer rate.

In addition, by applying a switching communication method through an RF switch, high-frequency wireless communication can be achieved through one antenna without a reduction in transmission rate.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a configuration diagram illustrating a high-frequency wireless data communication system according to the present disclosure;

FIG. 2 is a configuration diagram illustrating main parts of the high-frequency wireless data communication system shown in FIG. 1;

FIG. 3 is a configuration diagram illustrating a data conversion part of the high-frequency wireless data communication system shown in FIG. 1;

FIG. 4 is a configuration diagram illustrating an RF part of the high-frequency wireless data communication system shown in FIG. 1;

FIG. 5 is a diagram illustrating transmission flow of data of the RF part of the high-frequency wireless data communication system shown in FIG. 1;

FIGS. 6 to 13 are diagrams illustrating the tasks performed by the data conversion part of the high-frequency wireless data communication system shown in FIG. 1; and

FIGS. 14 to 16 are diagrams illustrating a SerDes of the high-frequency wireless data communication system shown in FIG. 1.

### DETAILED DESCRIPTION OF THE INVENTION

The above-described features and effects of the present disclosure will be more clearly understood from the following detailed description with reference to the accompanying drawings. Accordingly, those skilled in the art to which the present disclosure pertains can easily embody the technical idea of the present disclosure. The present disclosure may be modified in various ways and implemented by various embodiments, so that exemplary embodiments are shown in the drawings and will be described in detail. However, there is no intent to limit the present disclosure, and it is to be understood that the exemplary embodiments include all modifications, equivalents, or substitutes in the idea and the technical scope of the present disclosure. The terms used in the present application are merely used to describe the embodiments, and are not intended to limit the present disclosure.

Hereinafter, exemplary embodiments of the present disclosure will be described in detail with reference to the accompanying drawings.

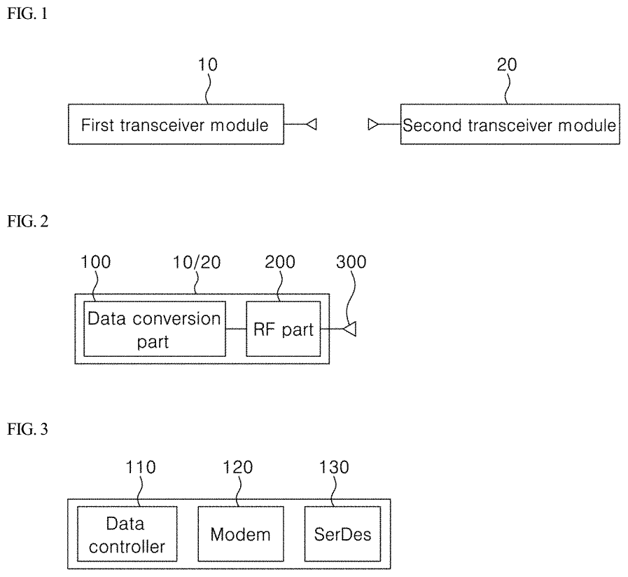

FIG. 1 is a configuration diagram illustrating a high-frequency wireless data communication system according to the present disclosure. FIG. 2 is a configuration diagram illustrating main parts of the high-frequency wireless data communication system shown in FIG. 1.

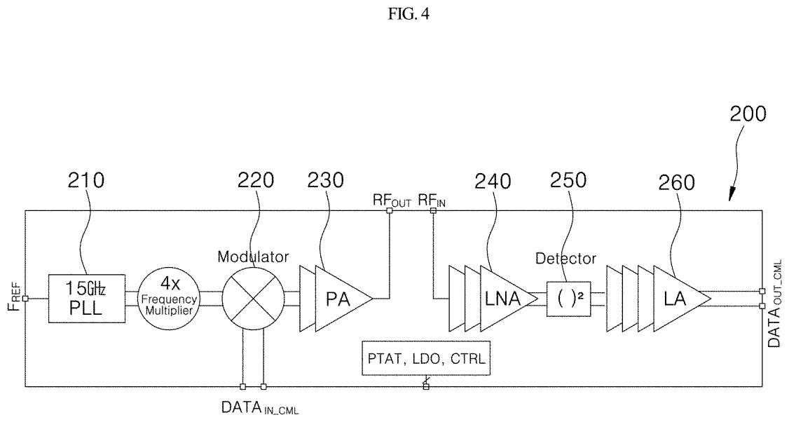

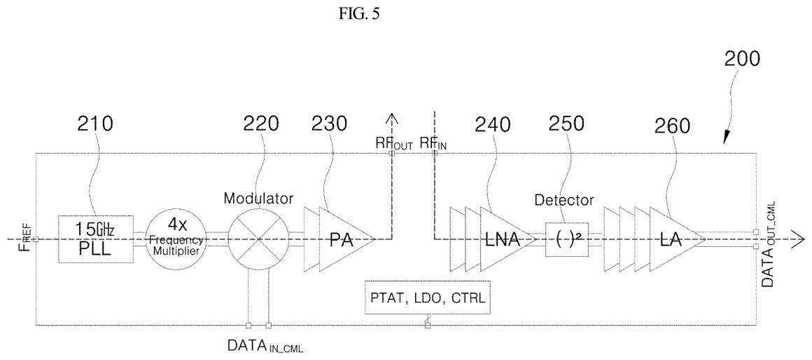

FIG. 3 is a configuration diagram illustrating a data conversion part of the high-frequency wireless data communication system shown in FIG. 1. FIG. 4 is a configuration diagram illustrating an RF part of the high-frequency wireless data communication system shown in FIG. 1. FIG. 5 is a diagram illustrating transmission flow of data of the RF part of the high-frequency wireless data communication system shown in FIG. 1.

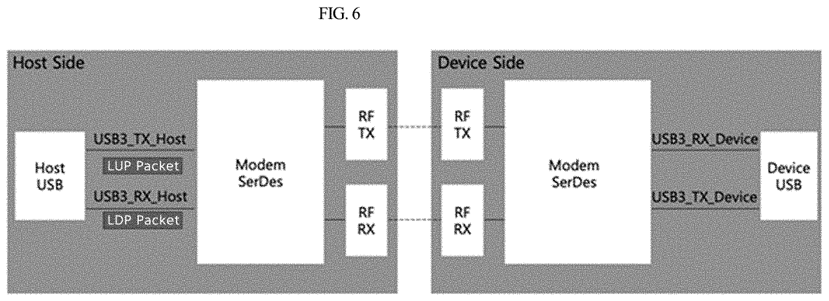

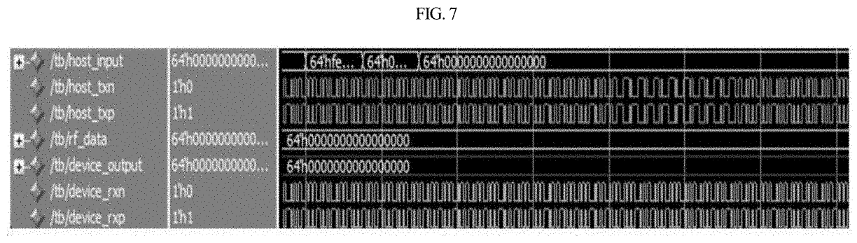

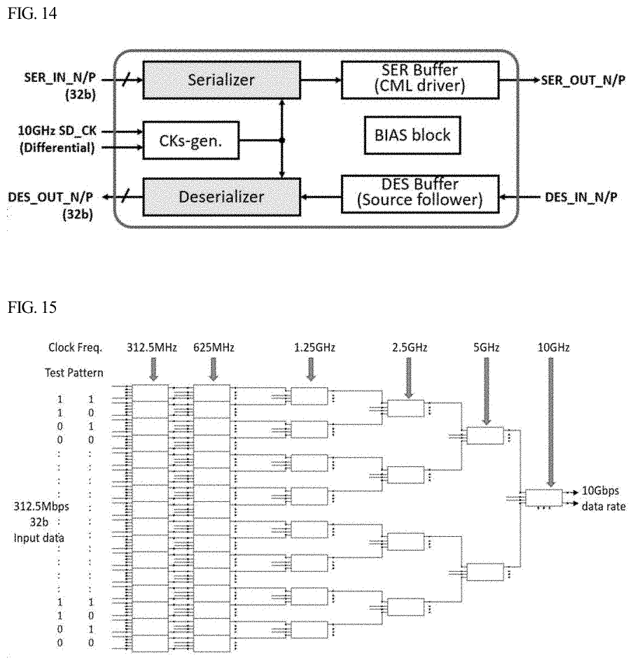

FIGS. 6 to 13 are diagrams illustrating the tasks performed by the data conversion part of the high-frequency wireless data communication system shown in FIG. 1. FIGS. 14 to 16 are diagrams illustrating a SerDes of the high-frequency wireless data communication system shown in FIG. 1.

With reference to these, describing a high-frequency wireless data communication system according to a first embodiment of the present disclosure, a first transceiver module 10 and a second transceiver module 20 are included as shown in FIG. 1.

The first transceiver module 10 may be provided or embedded in a first device (not shown).

In the meantime, the second transceiver module 20 may be provided or embedded in a second device (not shown).

When the first device and the second device want to transmit and receive data therebetween, the first transceiver module 10 and the second transceiver module 20 interwork with each other to transmit and receive data in a wireless manner via respective antennas 300.

As shown in FIG. 2, the first transceiver module 10 and the second transceiver module 20 have the same structure, and each include a data conversion part 100 and an RF part 200, and each may further include an antenna 300.

Herein, the data conversion part 100 and the RF part 200 may be realized in one extremely high frequency (EHF) chip capable of transmitting Gbps data. Therefore, the first transceiver module 10 or the second transceiver module 20 may be actually one EHF chip in which the data conversion part 100 and the RF part 200 are realized, except for a physical interface for connection to devices.

Herein, the antenna 300 may be a built-in antenna embedded in each of the transceiver modules 10 and 20, or may be an external antenna exposed to the outside of the transceiver module, but is not limited thereto.

The data conversion part 100 converts data-link layer data into physical-layer data, or converts physical-layer data into data-link layer data. Herein, regarding data transfer paths, a signal is transmitted from the data conversion part 100 to the RF part 200 at the time of transmission, and a signal is transmitted from the RF part 200 to the data conversion part 100 at the time of reception.

The data conversion part 100 may only perform a function of converting data-link layer data into physical-layer data or converting physical-layer data into data-link layer data, and may not include a modem or a SerDes.

The data conversion part 100 converts data-link layer data into physical-layer data, or converts physical-layer data into data-link layer data. Herein, regarding data transfer paths, a signal is transmitted from the data conversion part 100 to the RF part 200 at the time of transmission, and a signal is transmitted from the RF part 200 to the data conversion part 100 at the time of reception.

As shown in FIGS. 4 and 5, the RF part 200 includes a phase-locked loop (PLL) 210, a modulator (Modulator) 220, an amplifier (PA) 230, a low noise amplifier (LNA) 240, a demodulator (Detector) 250, and a limiter (LA) 260, and may further include an RF switch (not shown).

Herein, regarding data transfer paths, as shown in FIG. 5, a signal is transmitted from the phase-locked loop 210 to the modulator 220 and the amplifier 230 in that order at the time of transmission, and a signal is transmitted from the low noise amplifier 240 to the demodulator 250 and the limiter 260 in that order at the time of reception.

In summary, the first transceiver module 10 and the second transceiver module 20 have the same components. At the time of transmission, the data conversion part 100 receives data from the first device or the second device and transmits the data in a wireless manner through the RF part 200. At the time of reception, a signal is received in a wireless manner through the RF part 200 and is received by the first device or the second device through the data conversion part 100.

Herein, the path for transmission is referred to as a transmission (Tx) path, and the path for reception is referred to as a reception (Rx) path.

In the transmission (Tx) path, data-link layer data is converted into physical-layer data and the physical-layer data is transmitted in a wireless manner. In the reception (Rx) path, physical-layer data transmitted through wireless communication is converted into data-link layer data and the data-link layer data is transferred.

To this end, in the transmission (Tx) path, the data conversion part 100 and the RF part 200 are included in that order. In the reception (Rx) path, opposite to the transmission(Tx) path, the RF part 200 and the data conversion part 100 are included in that order.

Briefly describing the task that each component performs, on the transmission path, the data conversion part 100 converts data-link layer data into physical-layer data, and the RF part 200 fuses the physical-layer data into a frequency for conversion into a wireless signal.

In the meantime, on the reception path, the RF part 200 receives a wireless signal transmitted and separates a frequency from the wireless signal to extract physical-layer data, and the data conversion part 100 converts the physical-layer data into data-link layer data.

Describing this in more detail, the transmission path includes the data conversion part 100, the phase-locked loop 210, the modulator 220, and the amplifier 230 of the RF part 200 in that order, and the reception path includes the low noise amplifier 240, the demodulator 250, the limiter 260 of the RF part 200, and the data conversion part 100 in that order.

Hereinafter, the configuration, operation, and performed tasks of the data conversion part 100 and the RF part 200 will be described.

The data conversion part 100 is connected to the first device or the second device. At the time of transmission, the data conversion part 100 converts data-link layer data transferred from the device into physical-layer data for wireless communication and transmits the physical-layer data to the RF part 200. At the time of reception, the data conversion part 100 converts physical-layer data for wireless communication transmitted from the RF part 200 into data-link layer data and transmits the data-link layer data to the device connected to the data conversion part 100.

Herein, when data-link layer data is converted into physical-layer data for wireless communication (that is, when operation on the transmission path takes place), the data conversion part 100 adds a preamble to actual transmission data (payload) for transmission timing synchronization.

In addition to the preamble, a header for the type, form, error correction, and error detection for each transmission section of the actual transmission data (payload) may be further added.

Furthermore, a plurality of tasks, such as packaging of each piece of data, may be performed.

For example, as shown in FIG. 6, an LUP or LDP packet may be processed, and as shown in FIG. 7, an LDN or LUP (when there is no link command to transmit) command may be generated.

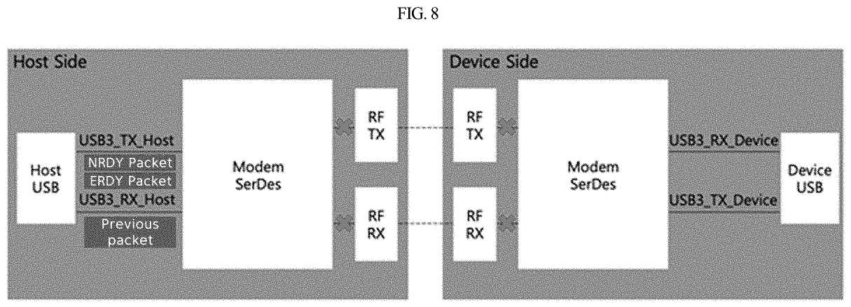

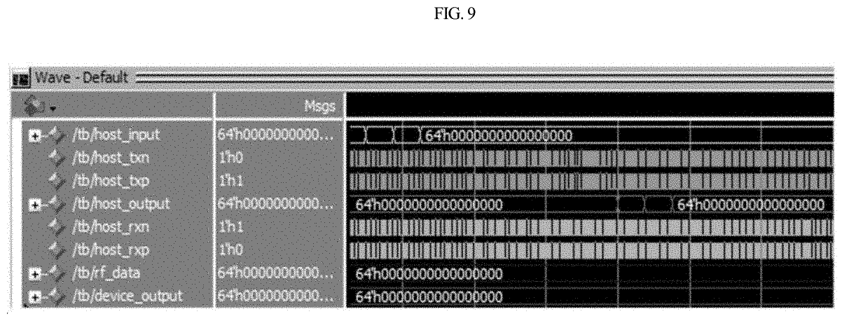

In addition, as shown in FIG. 8, NRDY packet processing may be performed, and as shown in FIG. 9, a previous-packet retransmission task due to NRDY response from the Rx side may be performed.

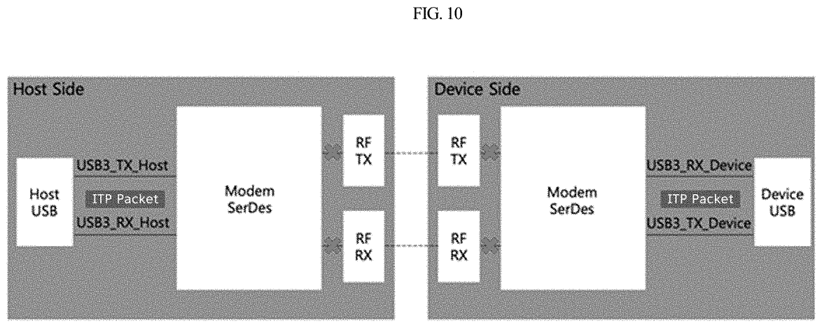

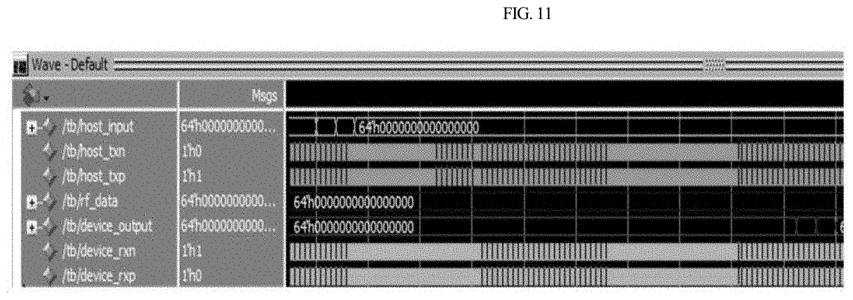

In addition, as shown in FIG. 10, ITP packet processing may be performed, and as shown in FIG. 11, ITP packet transmission may be performed.

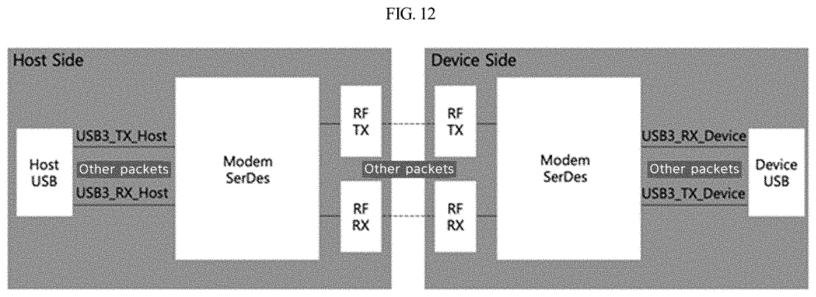

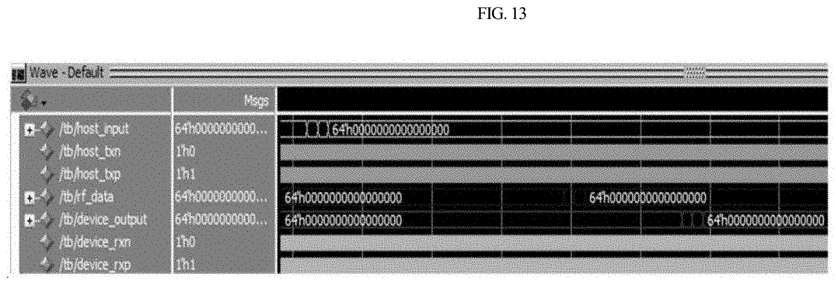

In addition, as shown in FIG. 12, other-packet processing may be performed, and as shown in FIG. 13, an other-packet transmission task may be performed.

In the meantime, when operation on the reception path takes place, the data conversion part 100 uses the header and preamble information to adjust transmission timing and perform data packaging distinction of actual transmission data (payload), and error detection and correction tasks, so that actual transmission data is reliably received and transferred.

In the meantime, in order to communicate in a wireless manner without reducing the transmission rate between each device and the first transceiver module 10 or the second transceiver module 20, when the first transceiver module 10 and the second transceiver module 20 perform wireless communication with each other, extremely high frequency(EHF) wireless communication is performed using a full-duplex method.

Describing the RF part with reference to FIGS. 4 and 5, the RF part 200 includes, as described above, the phase-locked loop (PLL) 210, the modulator (Modulator) 220, the amplifier (PA) 230, the low noise amplifier (LNA) 240, the demodulator (Detector) 250, and the limiter (LA) 260.

The RF part 200 is connected to the data conversion part 100. When performing a task on the transmission path, the RF part 200 fuses a signal transferred from the data conversion part 100 into a frequency for conversion into a wireless signal. When performing a task on the reception path, the RF part 200 separates a frequency from a wireless signal transmitted via the antenna 300 and transfers a signal resulting from the separation from the frequency, to the data conversion part 100.

The RF part 200 is connected to the antenna and is to modulate an electrical signal into a wireless frequency signal or to demodulate the electrical signal from the frequency signal. To this end, the RF part 200 may include the phase-locked loop (PLL) 210, the modulator (Modulator) 220, the amplifier (PA) 230, the low noise amplifier (LNA) 240, the demodulator (Detector) 250, and the limiter (LA) 260.

The phase-locked loop 210 generates a predetermined operating frequency that may include a frequency in a band ranging from 30 GHz to 300 GHz for high-frequency communication, but is not limited thereto.

The modulator 220 modulates a signal transferred from the data conversion part 100, on the basis of a signal generated from the phase-locked loop 210. This means a task of synthesizing a data signal to a frequency generated from the phase-locked loop 210 for loading to a frequency.

Herein, the modulator 220 may perform on-off keying (OOK) modulation, but is not limited thereto.

The amplifier 230 amplifies the frequency signal to which such data is fused.

The amplified signal is transmitted and received in a wireless manner via the antenna. Herein, the antenna may be embedded in one chip in which the data conversion part 100 and the RF part 200 are realized. In the meantime, in teams of the one chip, the antenna may be an external antenna that is installed separately from the one chip and electrically connected to the chip.

A plurality of antennas may be provided to realize a full-duplex method and the antennas for transmission and reception may be separately present.

In other words, at the time of wireless transmission, the amplifier 230 transmits a wireless signal via the antenna for transmission. At the time of wireless reception, the low noise amplifier 240 receives a wireless signal via the antenna for reception.

The low noise amplifier 240 operates on the reception path, and receives and amplifies a predetermined operating frequency signal transmitted from the antenna, to minimize noise.

The received and amplified signal is transferred to the demodulator 250, and the demodulator 250 receives the signal and performs a demodulation task of separating a frequency signal and a data signal. Herein, during demodulation, on-off keying (OOK) demodulation may be performed as in the modulator 220. If the modulator 220 performs another type of modulation, it is natural that the demodulator 250 performs the same type of demodulation as the modulator 220.

The limiter 260 is to remove the noise of the signal transferred from the demodulator 250, and transfers a resulting signal to the data conversion part 100.

The signal transferred to the data conversion part 100 is transferred back to the first device or to the second device, and communication is finished.

The wireless data communication system according to the first embodiment of the present disclosure has been described. Next, assuming the case in which data is transmitted from the first device to the second device, the transmission path and the reception path will be described in order.

In this case, the first transceiver module 10 operates on the transmission path and the second transceiver module 20 operates on the reception path.

Regarding the transmission path first, when data is intended to be transmitted from the first device to the second device, the data is transmitted from the first device to the first transceiver module 10 connected to or embedded in the first device.

Herein, the data is transmitted to the data conversion part 100 of the first transceiver module 10, and the data conversion part 100 converts data-link layer data into physical-layer data and transfers the physical-layer data to the RF part 200. Herein, as described above, a preamble and a head may be added during data conversion, and various tasks may be performed.

The modulator 220 of the RF part 200 modulates, on the basis of a frequency signal generated from the phase-locked loop 210, a signal transferred from the data conversion part 100 to the frequency through the OOK scheme or other schemes set by a user.

The modulated signal is transferred to the antenna for transmission through the amplifier 230, and the antenna for transmission transmits a wireless signal.

Herein, as described above, the wireless signal may be transmitted using a full-duplex method.

The signal transmitted in a wireless manner may be transmitted to the second transceiver module 20 connected to or embedded in the second device.

From now on, the reception path applies.

The wireless signal received via the antenna for reception is amplified and subjected to noise minimization while passing through the low noise amplifier 240, and is transferred to the demodulator 250.

The demodulator 250 separates (demodulation) a high-frequency signal and a data signal from the received signal by using the scheme (for example, the OOK scheme) the same as the modulation scheme of the modulator 220, and transfers a signal resulting from the separation to the limiter 260.

The limiter 260 removes noise from the received signal and transfers a resulting signal to the data conversion part 100. The signal resulting from conversion by the data conversion part 100 is transferred to the second device, and data transfer is finished.

In the meantime, when data and signals are transmitted from the second device to the first device, only the positions of the second device and the first device are switched in the above-described process of transmitting data from the first device to the second device, and all the operations are nearly the same. Therefore, a description thereof will be omitted.

The high-frequency wireless data communication system according to the first embodiment of the present disclosure has been described. Accordingly, the user uses the high-frequency wireless data communication system according to the present disclosure, so that without using a wired cable, wireless communication between a first device and a second device is performed using an extremely high frequency (EHF) band (30˜300 GHz), thereby achieving very high speed data transmission and reception in a wireless manner.

In addition, without using a chipset having a USB IP, high-frequency wireless communication of USB data is achieved with one wireless communication chip, so that power consumption due to the use of a USB IP is reduced and the size of the whole communication unit is reduced.

In addition, wireless communication between a device and the first or second transceiver module is performed using a full-duplex method, so that wireless communication is achieved without a reduction in transmission rate.

The high-frequency wireless data communication system according to the first embodiment of the present disclosure has been described. Next, a high-frequency wireless data communication system according to a second embodiment of the present disclosure will be described.

Herein, the high-frequency wireless data communication system according to the second embodiment of the present disclosure includes a data conversion part 100 and an RF part 200 that are nearly the same as the data conversion part 100 and the RF part 200 of the first embodiment. Therefore, the same configuration and function will be omitted if possible, and the differences will be mainly described.

In the high-frequency wireless data communication system according to the second embodiment of the present disclosure, the data conversion part 100 includes, as shown in FIG. 3, a data controller 110, a modem 120, and a SerDes 130.

This part is the biggest difference from the first embodiment. In the first embodiment, the data conversion part does not include a modem or a SerDes, but in the second embodiment, the data conversion part includes a modem and a SerDes.

Herein, regarding data transfer paths in the second embodiment, a signal is transmitted from the data controller 110 to the modem 120 and the SerDes 130 in that order at the time of transmission, and a signal is transmitted from the SerDes 130 to the modem 120 and the data controller 110 in that order at the time of reception.

Herein, regarding data transfer paths, at the time of transmission, a wireless signal starts from one device, passes through the data conversion part 100 and through the RF part 200, and is transmitted via an antenna 300. At the time of reception, reversely, a wireless signal is received via the antenna 300, passes through the RF part 200 and through the data conversion part 100, and is transmitted to another device.

Describing this in more detail, at the time of transmission, a wireless signal starts from one device, and is transmitted to the data controller 110, the modem 120, the SerDes 130, a modulator 220, an amplifier 230, and the antenna 300 in that order. At the time of reception, a wireless signal is received via the antenna 300, and is transmitted to a low noise amplifier 240, a demodulator 250, a limiter 260, the SerDes 130, the modem 120, and the data controller 110 in that order.

Herein, the path for transmission is referred to as a transmission (Tx) path, and the path for reception is referred to as a reception (Rx) path, which is the same as in the first embodiment.

As in the first embodiment, in the transmission (Tx) path, data-link layer data is converted into physical-layer data and the physical-layer data is transmitted in a wireless manner, and in the reception (Rx) path, physical-layer data transmitted through wireless communication is converted into data-link layer data and the data-link layer data is transferred.

To this end, in the transmission (Tx) path, the data conversion part 100 and the RF part 200 are included in that order. In the reception (Rx) path, opposite to the transmission(Tx) path, the RF part 200 and the data conversion part 100 are included in that order.

Briefly describing the task that each component performs, on the transmission path, the data conversion part 100 converts data-link layer data into physical-layer data, and the RF part 200 fuses the physical-layer data into a frequency for conversion into a wireless signal.

In the meantime, on the reception path, the RF part 200 receives a wireless signal transmitted and separates a frequency from the wireless signal to extract physical-layer data, and the data conversion part 100 converts the physical-layer data into data-link layer data.

Describing this in more detail, the transmission path includes the data controller 110, the modem 120, and the SerDes 130 of the data conversion part 100, the phase-locked loop 210, the modulator 220, and the amplifier 230 of the RF part 200 in that order. The reception path includes the low noise amplifier 240, the demodulator 250, and the limiter 260 of the RF part 200, the SerDes 130, the modem 120, and the data controller 110 of the data conversion part 100 in that order.

Hereinafter, the configuration, operation, and performed tasks of the data conversion part 100 and the RF part 200 will be described.

As described above, the data conversion part 100 includes the data controller 110, the modem 120, and the SerDes 130.

The data controller 110 is connected to the first device or the second device. At the time of transmission, the data controller 110 converts data-link layer data transferred from the device into physical-layer data for wireless communication and transmits the physical-layer data to the modem 120. At the time of reception, the data controller 110 converts physical-layer data for wireless communication transmitted from the modem 120 into data-link layer data and transmits the data-link layer data to the device connected to the data controller 110.

Herein, when data-link layer data is converted into physical-layer data for wireless communication (that is, when operation on the transmission path takes place), the data controller 110 adds a preamble to actual transmission data (payload) for transmission timing synchronization.

In addition to the preamble, a header for the type, form, error correction, and error detection for each transmission section of the actual transmission data (payload) may be further added.

In addition, as shown in FIGS. 6 to 13, LUP or LDP packet processing, generation of an LDN or LUP (when there is no link command to transmit) command, NRDY packet processing, a previous-packet retransmission task due to NRDY response from the Rx side, ITP packet processing, ITP packet transmission, other-packet processing, and an other-packet transmission task may be performed.

In the meantime, when operation on the reception path takes place, the data controller 110 uses the header and preamble information to adjust transmission timing and perform data packaging distinction of actual transmission data (payload), and error detection and correction tasks, so that actual transmission data is reliably received and transferred.

The modem 120 is connected to the data controller 110, and modulates the data resulting from conversion by the data controller 110 into a signal appropriate for wireless transmission, or demodulates a wirelessly transmitted signal into a physical data signal.

In modulation of the data resulting from conversion by the data controller 110, the modem 120 performs modulation to have the transfer rate that is at least twice the transfer rate between the device and the data controller 110. In demodulation, the modem 120 restores the signal on which modulation has been performed to have the at least twice the transfer rate, to the original rate that is the transfer rate between the device and the data controller 110.

This is to communicate in a wireless manner without reducing the transmission rate between each device and the first transceiver module 10 or the second transceiver module 20. To this end, when the first transceiver module 10 and the second transceiver module 20 perform wireless communication with each other, extremely high frequency (EHF) wireless communication is performed using a time division duplex (TDD) method.

In this regard, the case in which data is transmitted from the first device to the second device will be described as an example.

First, data is transmitted at the rate of 4.8 Gbps, which is USB 3.0 standard, from the first device to the data controller 110.

The data transmitted at the transfer rate of 4.8 Gbps passes through the data controller 110 and is transmitted to the modem 120. The modem 120 modulates the data to have at least twice (for example, about 10 Gbps) the transfer rate.

The modulated signal is transmitted from the first transceiver module 10 to the second transceiver module 20, passing through the RF part 200 and the antenna. Herein, transmission is performed using a time division duplex (TDD) method.

The transmitted signal passes through the RF part 200 of the second transceiver module 20 and is transferred to the modem 120. The modem 120 of the second transceiver module 20 demodulates the signal to have the original rate that is the transfer rate of 4.8 Gbps back and a resulting signal is transferred to the data controller 110.

Therefore, even though the first transceiver module 10 and the second transceiver module 20 alternately preform a transmission-reception task or a reception-transmission task by dividing the time instantaneously according to a time division duplex (TDD) method, the actual transmission rate is 4.8 Gbps that is the original transfer rate of USB 3.0. Accordingly, practical full duplex is achieved without reducing the transfer rate.

In the meantime, when performing modulation of the data resulting from conversion and transfer by the data controller 110, that is, when operation on the transmission path takes place, the modem 120 allocates unique numbers or addresses for data classification and identification. In addition, when performing demodulation, that is, operation on the reception path takes place, the modem 120 classifies and/or identifies the data by using the allocated unique numbers or addresses for data classification and identification.

Accordingly, when a transmission task is performed, unique numbers or addresses for data classification and identification are allocated. When a reception task is performed, the data is classified and/or identified with the allocated unique numbers or addresses for data classification and identification.

The SerDes 130 performs a task of serializing or parallelizing a signal. The SerDes 130 operates between the modem 120 and the RF part 200. The SerDes 130 serializes a signal transmitted from the modem 120 and transfers a resulting signal to the RF part 200, and parallelizes a signal transmitted from the RF part 200 and transfers a resulting signal to the modem 120.

As shown in FIGS. 14 and 15, the SerDes 130 may include a serializer (no reference numeral), a clock generator (CKs-gen.) (no reference numeral), a deserializer (no reference numeral), and buffers (SER Buffer and DES Buffer), and may perform serialization and parallelization tasks.

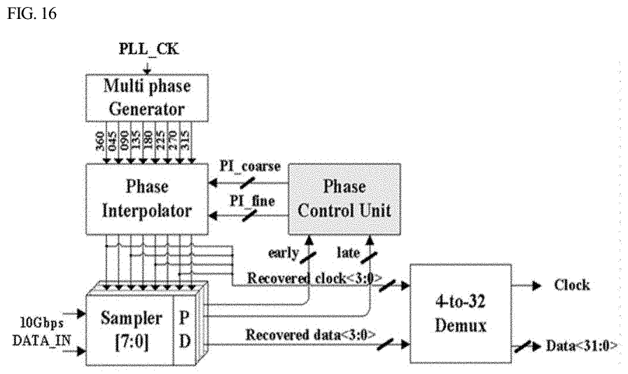

The deserializer (Deserializer) may include, as shown in FIG. 16, a multi phase generator, a phase interpolator, a sampler, a phase control unit, and a 4-to-32 demux.

Therefore, it may be expressed that the SerDes 130 performs a serialization task when performing a task on the transmission path, and performs a parallelization task when performing a task on the reception path.

As described above, the RF part 200 includes the phase-locked loop (PLL) 210, the modulator (Modulator) 220, the amplifier (PA) 230, the low noise amplifier (LNA) 240, the demodulator (Detector) 250, and the limiter (LA) 260, and may further include an RF switch (not shown).

Herein, compared to the RF part of the high-frequency wireless data communication system according to the first embodiment, the RF part of the high-frequency wireless data communication system according to the second embodiment may include an RF switch, which is the difference from the first embodiment.

The RF part 200 is connected to the SerDes 130. When performing a task on the transmission path, the RF part 200 fuses a signal transferred from the SerDes 130 into a frequency for conversion into a wireless signal. When performing a task in the reception path, the RF part 200 separates a frequency from a wireless signal transmitted via the antenna 300 and transfers a signal resulting from the separation from the frequency, to the SerDes.

The RF part 200 is connected to the antenna and is to modulate an electrical signal into a wireless frequency signal or to demodulate the electrical signal from the frequency signal. To this end, the RF part 200 may include the phase-locked loop (PLL) 210, the modulator (Modulator) 220, the amplifier (PA) 230, the low noise amplifier (LNA) 240, the demodulator (Detector) 250, and the limiter (LA) 260, and may further include the RF switch (not shown).

The phase-locked loop 210 generates a predetermined operating frequency that may include a frequency in a band ranging from 30 GHz to 300 GHz for high-frequency communication, but is not limited thereto.

The modulator 220 modulates a signal transferred from the SerDes 130, on the basis of a signal generated from the phase-locked loop 210. This means a task of synthesizing a data signal to a frequency generated from the phase-locked loop 210 for loading to a frequency.

Herein, the modulator 220 may perform on-off keying (OOK) modulation, but is not limited thereto.

The amplifier 230 amplifies the frequency signal to which such data is fused.

The amplified signal is transmitted and received in a wireless manner via the antenna. Herein, the antenna may be embedded in one chip in which the data conversion part 100 and the RF part 200 are realized. In the meantime, in teams of the one chip, the antenna may be an external antenna that is installed separately from the one chip and electrically connected to the chip.

A plurality of antennas may be provided and the antennas for transmission and reception may be separately present. In this case, the antenna for transmission may be connected to the amplifier 230 of the RF part 200, and the antenna for reception may be connected to the low noise amplifier 240.

In the meantime, one antenna may be shared for use. To this end, the RF part 200 of the high-frequency wireless data communication system according to the present disclosure may include the RF switch (not shown).

Therefore, by the RF switch, the antenna may be connected with the amplifier 230 when a task is performed on the transmission path, and the antenna may be connected with the low noise amplifier 240 when a task is performed on the reception path.

In other words, the RF switch is selectively connected to the amplifier 230 or the low noise amplifier 240. Herein, the RF switch connects the amplifier 230 with the antenna when wireless transmission is performed, and connects the low noise amplifier 240 with the antenna when wireless reception is performed.

Linking this to the transfer rate increase modulation operation, the TDD wireless communication, and the transfer rate restoration demodulation operation of the modem 120 described above, in the state in which the transfer rate is increased by twice or more in the modem 120, the time is selectively divided by the RF switch and TDD transmission and reception are performed, and then the transfer rate is restored to the original rate, whereby the user can use practical wireless communication without a reduction in transfer rate.

The low noise amplifier 240 operates on the reception path, and receives and amplifies a predetermined operating frequency signal transmitted from the antenna, to minimize noise.

The received and amplified signal is transferred to the demodulator 250, and the demodulator 250 receives the signal and performs a demodulation task of separating a frequency signal and a data signal. Herein, during demodulation, on-off keying (OOK) demodulation may be performed as in the modulator 220. If the modulator 220 performs another type of modulation, it is natural that the demodulator 250 performs the same type of demodulation as the modulator 220.

The limiter 260 is to remove the noise of the signal transferred from the demodulator 250, and transfers a resulting signal to the SerDes 130 of the data conversion part 100.

The signal transferred to the SerDes 130 passes through the modem 120 and the data controller 110 and is transferred back to the first device or to the second device, and communication is finished.

The high-frequency wireless data communication system according to the present disclosure has been described. Next, assuming the case in which data is transmitted from the first device to the second device, the transmission path and the reception path will be described in order.

In this case, the first transceiver module 10 operates on the transmission path and the second transceiver module 20 operates on the reception path.

Regarding the transmission path first, when data is intended to be transmitted from the first device to the second device, the data is transmitted from the first device to the first transceiver module 10 connected to or embedded in the first device.

Herein, the data is transmitted to the data conversion part 100 of the first transceiver module 10, specifically, to the data controller 110, and the data controller 110 converts data-link layer data into physical-layer data and transfers the physical-layer data to the modem 120. Herein, as described above, a preamble and a head may be added during data conversion, and various tasks may be performed.

The modem 120 receives the data, modulates the data to have the transfer rate that is at least twice the transfer rate from the first device to the first transceiver module 10, and transfers resulting data to the SerDes 130.

Herein, when performing modulation of the data resulting from conversion and transfer by the data controller 110, the modem 120 may allocate unique numbers or addresses for data classification and identification.

The SerDes 130 serializes the signal transferred from the modem 120 and transmits a resulting signal to the RF part 200.

Herein, the modulator 220 of the RF part 200 modulates, on the basis of a frequency signal generated from the phase-locked loop 210, a signal transferred from the SerDes 130 to the frequency through the OOK scheme or other schemes set by the user.

The modulated signal is transferred to the RF switch through the amplifier 230, and the RF switch connects the amplifier 230 with the antenna to perform transmission and transmits a wireless signal via the antenna.

Herein, as described above, the wireless signal may be transmitted using a TTD method.

The signal transmitted in a wireless manner may be transmitted to the second transceiver module 20 connected to or embedded in the second device.

From now on, the reception path applies. Describing the wireless transmission in more detail, a wireless signal transmitted from the antenna of the first transceiver module 10 is transmitted to the antenna of the second transceiver module 20. Herein, for reception, the RF switch of the second transceiver module 20 connects the antenna with the low noise amplifier 240 of the second transceiver module 20.

The wireless signal transmitted to the low noise amplifier 240 is transferred to the demodulator 250.

The demodulator 250 separates (demodulation) a high-frequency signal and a data signal from the received signal by using the scheme (for example, the OOK scheme) the same as the modulation scheme of the modulator 220, and transfers a signal resulting from the separation to the limiter 260.

The limiter 260 removes noise from the received signal and transfers a resulting signal to the SerDes 130. The signal passed through the SerDes 130 is demodulated by the modem 120 and a resulting signal is transferred to the second device through the data controller 110, and data transfer is finished.

Herein, as described above, in demodulation of data transferred through the SerDes 130, the modem 120 restores more than twice the transfer rate to the transfer rate between the first device and the data controller 110 of the first transceiver module 10.

In addition, it is natural that the modem 120 of the second transceiver module 20 classifies and/or identifies data with the unique numbers or addresses for data classification and identification allocated by the transmission side, that is, the modem 120 of the first transceiver module 10.

In the meantime, when data and signals are transmitted from the second device to the first device, only the positions of the second device and the first device are switched in the above-described process of transmitting data from the first device to the second device, and all the operations are nearly the same. Therefore, a description thereof will be omitted.

The high-frequency wireless data communication system according to the second embodiment of the present disclosure has been described. Accordingly, the user uses the high-frequency wireless data communication system according to the present disclosure, so that without using a wired cable, wireless communication between a first device and a second device is performed using an extremely high frequency (EHF) band (30˜300 GHz), thereby achieving very high speed data transmission and reception in a wireless manner.

In addition, without using a chipset having a USB IP, high-frequency wireless communication of USB data is achieved with one wireless communication chip, so that power consumption due to the use of a USB IP is reduced and the size of the whole communication unit is reduced.

In addition, modulation is performed to have the data transfer rate that is at least twice the data transfer rate between a device and a first or second transceiver module, and wireless communication is performed, so that practical full duplex is achieved or the high-frequency wireless data communication system operating in a time division duplex (TDD) method is used without a reduction in transfer rate.

In addition, by applying a switching communication method through an RF switch, extremely high frequency wireless communication is achieved through one antenna without a reduction in transmission rate.

The configuration and operation of the high-frequency wireless data communication system according to the present disclosure have been described. Although the present disclosure has been described with reference to the exemplary embodiments, those skilled in the art will appreciate that various modifications and variations can be made in the present disclosure without departing from the idea and the technical scope of the disclosure described in the appended claims.

What is claimed is:

1. A high-frequency wireless data communication system, comprising:
a first transceiver module provided or embedded in a first device, and configured to perform wireless communication, the first device being capable of storing data therein or processing data; and
a second transceiver module provided or embedded in a second device, and configured to perform wireless communication with the first transceiver module, the second device being capable of storing data therein or processing data,
wherein the first and the second transceiver module each include an extremely high frequency (EHF) chip capable of transmitting Gbps data, and
when the second device is intended to transmit data to and receive data from the first device, the first transceiver module and the second transceiver module interwork with each other and transmit and receive data in a wireless manner.

2. The high-frequency wireless data communication system of claim 1, wherein the EHF chip of the first transceiver module and the EHF chip of the second transceiver module each comprises:
a transmission (Tx) path on which data-link layer data is converted into physical-layer data and the physical-layer data is transmitted in a wireless manner; and
a reception (Rx) path on which physical-layer data transmitted through wireless communication is converted into data-link layer data and the data-link layer data is transferred.

3. The high-frequency wireless data communication system of claim 2, wherein the transmission path comprises:
a data conversion part connected to the first device or the second device, and configured to convert data-link layer data into physical-layer data for wireless communication; and
an RF part configured to fuse the physical-layer data into a frequency for conversion into a wireless signal.

4. The high-frequency wireless data communication system of claim 2, wherein the reception path comprises:
an RF part configured to separate a frequency from a wireless signal transmitted from the first device or the second device to extract physical-layer data; and
a data conversion part connected to the first device or the second device, and configured to convert the physical-layer data into data-link layer data.

5. The high-frequency wireless data communication system of claim 2, wherein the first transceiver module and the second transceiver module each further comprise an antenna for wireless communication.

6. The high-frequency wireless data communication system of claim 3, wherein the data conversion part is configured to add, when converting the data-link layer data into the physical-layer data for wireless communication, a preamble to actual transmission data (payload) for transmission timing synchronization.

7. The high-frequency wireless data communication system of claim 6, wherein the data conversion part is configured to further add a header for a type, a form, error correction, and error detection for each transmission section of the actual transmission data (payload).

8. The high-frequency wireless data communication system of claim 3, wherein the RF part on the transmission path comprises:
a phase-locked loop (PLL) configured to generate a predetermined operating frequency;
a modulator (Modulator) configured to modulate a signal transferred from the data conversion part, on the basis of a signal generated from the phase-locked loop (PLL); and
an amplifier (PA) configured to amplify a signal transferred from the modulator.

9. The high-frequency wireless data communication system of claim 4, wherein the RF part on the reception path comprises:
a low noise amplifier (LNA) configured to receive and amplify a predetermined operating frequency signal transmitted from the first transceiver module and the second transceiver module, to minimize noise;
a demodulator (Detector) configured to demodulate a signal transferred from the low noise amplifier (LNA); and
a limiter configured to remove the noise.

10. The high-frequency wireless data communication system of claim 1, wherein when performing wireless communication, the first transceiver module and the second transceiver module perform the wireless communication through a full duplex method.

11. The high-frequency wireless data communication system of claim 10, wherein during the wireless communication, a frequency in a band ranging from 30 GHz to 300 GHz is used.

12. The high-frequency wireless data communication system of claim 3, wherein the data conversion part on the transmission path comprises:
a data controller connected to the first device or the second device, and configured to convert the data-link layer data into the physical-layer data for wireless communication;
a modem connected to the data controller, and configured to modulate data resulting from conversion by the data controller into a signal appropriate for wireless transmission; and
a SerDes connected to the modem, and configured to serialize a signal.

13. The high-frequency wireless data communication system of claim 4, wherein the data conversion part on the reception path comprises:
a SerDes configured to parallelize a signal transferred from the RF part;
a modem configured to demodulate the parallelized signal into a physical data signal; and
a data controller configured to convert physical data resulting from demodulation into the data-link layer data.

14. The high-frequency wireless data communication system of claim 13, wherein when modulating data resulting from conversion and transfer by the data controller, the modem is configured to perform modulation to have a transfer rate that is at least twice a transfer rate of data transmitted from the first device or the second device to the first or the second transceiver module on the transmission path.

15. The high-frequency wireless data communication system of claim 14, wherein when demodulating data transferred through the SerDes, the modem is configured to perform demodulation so that a transfer rate of the demodulated data is equal to a transfer rate of data transmitted from the first device or the second device to the first or the second transceiver module on the transmission path.

16. The high-frequency wireless data communication system of claim 9, wherein the RF part further comprises an RF switch connected to an amplifier (PA) or the low noise amplifier (LNA), wherein the RF switch is configured to connect the amplifier (PA) with an antenna at the time of transmission, and is configured to connect the low noise amplifier (LNA) with the antenna at the time of wireless reception.

17. The high-frequency wireless data communication system of claim 13, wherein when performing wireless communication, the first transceiver module and the second transceiver module perform the wireless communication through a time division duplex (TDD) method.

18. The high-frequency wireless data communication system of claim 17, wherein during the wireless communication, a frequency in a band ranging from 30 GHz to 300 GHz is used.
